(19) United States
(12) Patent Application Publication
(10) Pub. No.: US 2025/0297134 A1
(43) Pub. Date: Sep. 25, 2025

(54) HIGH RATE BULK OXIDE CMP COMPOSITION

(71) Applicant: ENTEGRIS, INC., Billerica, MA (US)

(72) Inventors: Alexander W. Hains, Aurora, IL (US); Qiang Zhao, Woodridge, IL (US); Juyeon Chang, Bolingbrook, IL (US); Douglas Robello, Aurora, IL (US); Steven Kraft, Aurora, IL (US)

(21) Appl. No.: 19/088,954

(22) Filed: Mar. 24, 2025

Related U.S. Application Data
(60) Provisional application No. 63/569,621, filed on Mar. 25, 2024.

(51) Int. Cl. C09G 1/02; C09K 3/14

(52) U.S. Cl. CPC C09G 1/02; C09K 3/1409

(57) ABSTRACT

A chemical mechanical polishing composition comprises, consists of, or consists essentially of a liquid carrier, ceria particles dispersed in the liquid carrier, the ceria particles having a weight average particle size of greater than 90 nm as measured using a CPS Disc Centrifuge Particle size analyzer and a BET surface area of greater than 50 m²/g; and a hydroxamic acid or a pyrone compound.

### BACKGROUND OF THE INVENTION

Chemical mechanical polishing (CMP) compositions and methods for polishing (or planarizing) the surface of a substrate are well known. Polishing compositions (also known as polishing slurries, CMP slurries, and CMP compositions) for polishing various dielectric layers (such as silicon oxide) on a semiconductor substrate may include abrasive particles (e.g., including ceria or silica particles) dispersed in an aqueous carrier and various chemical additives such as polishing rate accelerators and inhibitors, topography control agents, buffers, and the like.

CMP has long been employed to planarize dielectric layers. In example processes, dielectric material may be deposited over a structured substrate. Some amount of the resulting patterned dielectric may then be removed to planarize the substrate. Process metrics may include step height reduction, trench loss, and planarization efficiency as is known to those of ordinary skill in the art. In recent years, dielectric CMP has been used in fabricating 3D NAND flash memory device substrates. 3D NAND flash memory device fabrication involves building memory components in three dimensions on the substrate. Such substrates may therefore exhibit significantly increased step heights that have not generally been present in earlier generation devices. Moreover, there is a trend towards increasing dielectric layer thickness in advanced 3D NAND devices. These increased thicknesses and corresponding step heights generally require that a significantly higher amount of patterned dielectric material must be removed from a 3D NAND device substrate to generate a planarized surface.

While conventional dielectric CMP compositions may theoretically be utilized for polishing advanced 3D NAND flash memory devices, excessive polishing time is generally required to remove the excess dielectric material. The increased polishing time reduces throughput and increases costs. To maintain high throughput and economic efficiency during commercial fabrication, CMP compositions are needed that provide a very high dielectric removal rate. Therefore, there is a need for CMP compositions providing an improved dielectric removal rate.

### BRIEF SUMMARY OF THE INVENTION

A chemical mechanical polishing composition is disclosed. The composition comprises, consists of, or consists essentially of a liquid carrier; ceria particles dispersed in the liquid carrier, the ceria particles having a weight average particle size of greater than 90 nm as measured using a CPS Disc Centrifuge Particle size analyzer and a BET surface area of greater than 50 m²/g; and a hydroxamic acid or a pyrone compound.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIGS. 1A, 1B, and 1C (collectively FIG. 1) depict scanning electron microscopy images of example ceria particles disclosed herein.

### DETAILED DESCRIPTION OF THE INVENTION

Chemical mechanical polishing compositions and methods for using those compositions to polish a substrate are disclosed. In one example embodiment, a chemical mechanical polishing composition comprises, consists essentially of, or consists of an aqueous based liquid carrier; ceria particles dispersed in the liquid carrier, the ceria particles having a weight average particle size of greater than 90 nm as measured using a CPS Disc Centrifuge Particle size analyzer and a BET surface area of greater than 50 m²/g; and a hydroxamic acid or a pyrone compound. A method for polishing a dielectric-containing substrate includes contacting the substrate with one of the disclosed polishing compositions, moving the polishing composition relative to the substrate, and abrading the substrate to remove a portion of at least one dielectric layer (such as a silicon oxide-containing layer) from the substrate and thereby polish the substrate.

In example embodiments the ceria particles may include first ceria particles having a weight average particle size of greater than 100 nm as measured using a CPS Disc Centrifuge Particle size analyzer and second ceria particles having a weight average particle size between 30 nm and 60 nm as measured using a CPS Disc Centrifuge Particle size analyzer. For example, in such example embodiments, the first ceria particles may have a surface area of less than about 40 m²/g and the second ceria particles may have a surface area of greater than about 100 m²/g. Moreover, in such example embodiments, a weight ratio of the first ceria particles to the second ceria particles may be in a range from about 3:2 to about 9:1.

The disclosed embodiments may advantageously provide very high dielectric layer polishing results, particularly on patterned wafers such as those used in 3D NAND applications. For example, it has been found that compositions including the disclosed ceria particles (e.g., the disclosed first ceria particles and second ceria particles in various example embodiments) and a hydroxamic acid or pyrone compound provide very high dielectric layer polishing results.

The polishing composition contains ceria particles in a liquid carrier (e.g., suspended or dispersed in the liquid carrier). By ceria particles it is meant particles that are primarily or mostly ceria. Doped ceria particles or ceria particles including small amounts (e.g., a few percent) of other elements or compounds, such as other oxides, are well within the scope of the disclosed embodiments. In example embodiments, the ceria particles may be characterized as having an average particle size (such as a weight average particle size) greater than a first threshold and a surface area (such as a BET surface area) greater than a second threshold. For example, the ceria particles may be characterized as having a weight average particle size of greater than 70 nm (e.g., greater than 80 nm, greater than 85 nm, greater than 90 nm, greater than 95 nm, or greater than 100 nm) as measured using a CPS Disc Centrifuge Particle size analyzer and a Brunauer-Emmett-Teller (BET) surface area of greater than about 40 m²/g (e.g., greater than about 45 m²/g, greater than about 50 m²/g, greater than about 55 m²/g, or greater than about 60 m²/g). The BET surface area may further be less than about 120 m²/g (e.g., less than about 110 m²/g, less than about 100 m²/g, less than about 95 m²/g, or less than about 90 m²/g).

The example ceria particles may be further characterized as having a number average particle size of less than 70 nm (e.g., less than 60 nm, less than 55 nm, less than 50 nm, or less than 45 nm) as also measured using a CPS Disc Centrifuge Particle size analyzer. The example ceria particles may be still further characterized as having a number average particle size of less than 50 nm (e.g., less than 45 nm, less than 40 nm, less than 35 nm, or less than 30 nm) as also measured using differential mobility analysis (DMA).

The ceria particles may be present in the polishing composition at any suitable concentration. A desired concentration of ceria particles may depend upon many factors, for example, including the desired dielectric (e.g., TEOS) removal rate, the size of the substrate (e.g., wafers) being polished, the type of polishing tool being utilized, and cost constraints. In example embodiments, the ceria particles may be present in the polishing composition at a concentration of about 0.01 wt. % or more (e.g., about 0.1 wt. % or more, about 0.2 wt. % or more, about 0.3 wt. % or more, or about 5 wt. % or more). Alternatively, or in addition, the first ceria particles may be present in the polishing composition at a concentration of about 10 wt. % or less (e.g., about 8 wt. % or less, about 6 wt. % or less, about 5 wt. % or less, or about 4 wt. % or less). Accordingly, the first ceria particles may be present in the polishing composition at a concentration within a range bounded by any two of the aforementioned endpoints. For example, the first ceria particles may be present in the polishing composition at a concentration range from about 0.01 wt. % to about 10 wt. % (e.g., about 0.1 wt. % to about 5 wt. %). For CMP applications in which 200 mm wafers are polished, the amount of ceria particles present in the composition may advantageously be in a range from about 0.1 wt. % to about 2 wt. % (e.g., from about 0.2 wt. % to about 1 wt. %). For CMP applications in which 300 mm wafers are polished, the amount of ceria particles present in the composition may advantageously be in a range from about 0.5 wt. % to about 10 wt. % (e.g., from about 1 wt. % to about 5 wt. %).

In certain example embodiments, the disclosed polishing composition may include first ceria particles and second ceria particles. In such embodiments, the first ceria particles and the second ceria particles may include substantially any suitable ceria particles including, for example, fumed ceria particles, calcined ceria particles, or wet-process ceria particles (e.g., precipitated ceria particles or condensation-polymerized ceria particles, including colloidal ceria particles and cubiform ceria particles as disclosed in U.S. Patent Publication 2021/0115298). For example, in some example embodiments, the first ceria particles may include calcined ceria particles and the second ceria particles may include wet-process ceria particles.

The first ceria particles may have an average particle size of about 60 nm or more (e.g., about 70 nm or more, about 80 nm or more, about 85 nm or more, about 90 nm or more, about 95 nm or more, about 100 nm or more, about 105 nm or more, or about 110 nm or more). Alternatively, or in addition, the first ceria particles may have an average particle size of about 1 μm or less (e.g., about 800 nm or less, about 600 nm or less, about 500 nm or less, about 400 nm or less, about 300 nm or less, about 200 nm or less, or about 150 nm or less). Thus, the first ceria particles may have an average particle size within a range bounded by any two of the aforementioned endpoints. For example, the first ceria particles may have an average particle size of about 60 nm to about 1 μm (e.g., about 70 nm to about 600 nm, about 80 nm to about 400 nm, about 90 nm to about 200 nm, or about 100 nm to about 150 nm). It will be appreciated that all the ceria particle size specifications reported herein are weight average particle size as measured using a CPS Disc Centrifuge Particle size analyzer unless explicitly stated otherwise.

The first ceria particles may have a BET surface area greater than about 1 m²/g (e.g., greater than 2 m²/g, greater than 3 m²/g, greater than 4 m²/g, or greater than 5 m²/g). Alternatively, or in addition, the first ceria particles may have a BET surface area less than about 50 m²/g (e.g., less than about 40 m²/g, less than about 30 m²/g, less than about 25 m²/g, or less than about 20 m²/g). Accordingly, the first ceria particles may have a BET surface area bounded by any two of the aforementioned endpoints. For example, the first ceria particles may have a BET surface area in a range from about 1 m²/g to about 50 m²/g (e.g. from about 1 m²/g to about 40 m²/g, from about 3 m²/g to about 30 m²/g, from about 3 m²/g to about 25 m²/g, or from about 5 m²/g to about 20 m²/g).

The first ceria particles may be present in the polishing composition at any suitable concentration. For example, the first ceria particles may be present in the polishing composition at a concentration of about 0.1 wt. % or more (e.g., about 0.25 wt. % or more, about 0.5 wt. % or more, about 0.75 wt. % or more, about 1 wt. % or more, about 1.25 wt. % or more, about 1.5 wt. % or more, about 1.75 wt. % or more, about 2 wt. % or more, about 2.25 wt. % or more, or about 2.5 wt. % or more). Alternatively, or in addition, the first ceria particles may be present in the polishing composition at a concentration of about 5 wt. % or less (e.g., about 4 wt. % or less, about 3.75 wt. % or less, about 3.5 wt. % or less, about 3.25 wt. % or less, about 3 wt. % or less, about 2.75 wt. % or less, or about 2 wt. % or less). Accordingly, the first ceria particles may be present in the polishing composition at a concentration within a range bounded by any two of the aforementioned endpoints. For example, the first ceria particles may be present in the polishing composition at a concentration range from about 0.1 wt. % to about 5 wt. % (e.g., about 0.5 wt. % to about 4 wt. %, about 1 wt. % to about 4 wt. %, about 1.5 wt. % to about 3.5 wt. %, about 2 wt. % to about 3.5 wt. %, or about 2 wt. % to about 3 wt. %).

The second first ceria particles may have an average particle size of about 10 nm or more (e.g., about 20 nm or more, about 25 nm or more, about 30 nm or more, about 35 nm or more, about 40 nm or more, or about 45 nm or more). Alternatively, or in addition, the second ceria particles may have an average particle size of about 100 nm or less (e.g., about 80 nm or less, about 70 nm or less, about 60 nm or less, about 55 nm or less, or about 50 nm or less). Accordingly, the second ceria particles may have an average particle size within a range bounded by any two of the aforementioned endpoints. For example, the second ceria particles may have an average particle size of about 10 nm to about 100 nm (e.g., about 20 nm to about 80 nm, about 30 nm to about 80 nm, about 30 nm to about 60 nm, or about 40 nm to about 60 nm). As noted above, the ceria particle size reported herein are weight average particle size as measured using a CPS Disc Centrifuge Particle size analyzer unless explicitly stated otherwise.

The second ceria particles may have a BET surface area greater than about 20 m²/g (e.g., greater than 40 m²/g, greater than 60 m²/g, greater than 80 m²/g, greater than 100 m²/g, greater than 120 m²/g, greater than 140 m²/g, or greater than 150 m²/g). Alternatively, or in addition, the second ceria particles may have a BET surface area less than about 1000 m²/g (e.g., less than about 500 m²/g, less than about 400 m²/g, less than about 300 m²/g, or less than about 250 m²/g). Accordingly, the second ceria particles may have a BET surface area bounded by any two of the aforementioned endpoints. For example, the second ceria particles may have a BET surface area in a range from about 20 m²/g to about 1000 m²/g (e.g. from about 60 m²/g to about 500 m²/g, from about 100 m²/g to about 400 m²/g, from about 120 m²/g to about 300 m²/g, or from about 150 m²/g to about 250 m²/g).

The second ceria particles may be present in the polishing composition at any suitable concentration. For example, the second ceria particles may be present in the polishing composition at a concentration of about 0.01 wt. % or more (e.g., about 0.1 wt. % or more, about 0.15 wt. % or more, about 0.2 wt. % or more, about 0.25 wt. % or more, about 0.3 wt. % or more, about 0.35 wt. % or more, about 0.4 wt. % or more, about 0.45 wt. % or more, or about 0.5 wt. % or more). Alternatively, or in addition, the second ceria particles may be present in the polishing composition at a concentration of about 3 wt. % or less (e.g., about 2.5 wt. % or less, about 2 wt. % or less, about 1.75 wt. % or less, about 1.5 wt. % or less, about 1.25 wt. % or less, or about 1 wt. % or less). Accordingly, the second ceria particles may be present in the polishing composition at a concentration within a range bounded by any two of the aforementioned endpoints. For example, the second ceria particles may be present in the polishing composition at a concentration range from about 0.01 wt. % to about 3 wt. % (e.g., about 0.1 wt. % to about 2.5 wt. %, about 0.2 wt. % to about 2 wt. %, about 0.25 wt. % to about 1.5 wt. %, about 0.35 wt. % to about 1 wt. %, or about 0.5 wt. % to about 1 wt. %).

In example embodiments including first and second ceria particles, the first ceria particles may be comparatively large ceria particles, for example, having a weight average particle size of greater than 80 nm (e.g., greater than 90 nm, greater than 95 nm, greater than 100 nm, greater than 105 nm, or greater than 110 nm) and the second ceria particles may be comparatively small ceria particles, for example, having a weight average particle size of less 70 nm (e.g., less than 65 nm, less than 60 nm, less than 55 nm, or less than 50 nm) as measured using a CPS Disc Centrifuge Particle size analyzer. The first ceria particles may also have a number average particle size greater than 50 nm (e.g., greater than 55 nm or greater than 60 nm) and the second ceria particles may also have a number average particle size of less than 40 nm (e.g., less than 35 nm or less than 30 nm) as measured using a CPS Disc Centrifuge Particle size analyzer.

It will be appreciated that embodiments including first ceria particles and second ceria particles may further include third ceria particles (e.g., third ceria particles, fourth ceria particles, and so on) and/or other non-ceria particles (such as silica particles, alumina particles, and/or zirconia particles). Such third ceria particles and/or other non-ceria particles may have any suitable particle size and surface area and may be present in the polishing composition at any suitable concentration. The disclosed embodiments are expressly not limited to polishing compositions including only first ceria particles and second ceria particles.

In example embodiments the polishing composition may contain a low or intermediate concentration of the ceria particles (i.e., a low or intermediate solids content). A low or intermediate concentration of ceria particles may advantageously reduce costs while at the same time providing high dielectric removal rates. The polishing composition may include 5 wt. % or less of the ceria particles at point of use (e.g., 4.5 wt. % or less, or 4 wt. % or less). Alternatively, or in addition, the polishing composition may include 0.5 wt. % or more of the ceria particles at point of use (e.g., 1 wt. % or more or 2 wt. % or more). Accordingly, the polishing composition may include a concentration of the ceria particles within a range bounded by any two of the aforementioned endpoints. For example, the polishing composition may include from about 0.5 wt. % to about 5 wt. % (e.g., from about 1 wt. % to about 4.5 wt. % or from about 2 wt. % to about 4 wt. %).

In example embodiments in which the polishing composition includes first ceria particles and second ceria particles, the first and second ceria particles may be present in the polishing composition at any suitable ratio. The ratio of the second ceria particles to the first ceria particles may be determined (and is quantified below) on a weight basis. In particular, the ratio represents the ratio of the percentage of the second ceria particles to the percentage of the first ceria particles in the polishing composition. The ratio of the second ceria particles to the first ceria particles may be greater than about 1:19 (e.g., greater than about 1:14, greater than about 1:12, greater than about 1:9, or greater than about 1:4). Alternatively, or in addition, the ratio of the second ceria particles to the first ceria particles may be less than about 1:2 (e.g., less than about 1:1, less than about 3:4, less than about 2:3, or less than about 3:7). Accordingly, the ratio of the second ceria particles to the first ceria particles may be within a range bounded by any two of the aforementioned endpoints. For example, the ratio of the second ceria particles to the first ceria particles may be in a range from about 1:19 to about 2:1 (e.g., from about 1:14 to about 1:1 or from about 1:9 to about 2:3). In preferred embodiments that include first ceria particles and second ceria particles, the ratio of the second ceria particles to the first ceria particles may be in a range from about 1:4 to about 3:7.

A liquid carrier is generally used to facilitate the application of the ceria particles and any optional chemical additives to the surface of the substrate to be polished. The liquid carrier may include any suitable carrier (e.g., a solvent) including lower alcohols (e.g., methanol, ethanol, etc.), ethers (e.g., dioxane, tetrahydrofuran, etc.), water, and mixtures thereof. Preferably, the liquid carrier comprises, consists essentially of, or consists of water, more preferably deionized water.

The disclosed polishing compositions further include a hydroxamic acid compound (or a substituted hydroxamic acid compound) and/or a pyrone compound. A hydroxamic acid or substituted hydroxamic acid compound may be described by the following formula:

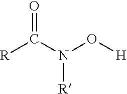

in which R and R′ are one or more selected from the group consisting of: hydrogen, alkyl, cycloalkyl, heterocyclic alkyl, aryl, and heterocyclic aryl, any of which may be substituted. The term “alkyl” as used herein allows for branching and straight-chain groups, and generally refers to a saturated group (e.g., —CnH₂ₙ₊) but does allow for a small degree of unsaturation, e.g., one carbon-carbon double bond or two carbon-carbon double bonds. A “substituted” group refers to a group in which a carbon-bonded hydrogen is replaced by a non-hydrogen atom such as a halide, or by a functional group such as an amine, hydroxide, etc. The hydroxamic acid or substituted hydroxamic acid may be included in a polishing composition in any chemical form, such as a free acid form or as a salt. In preferred embodiments R′ is hydrogen or methyl.

In example embodiments, the disclosed polishing compositions may include substantially any suitable hydrophobic hydroxamic acid compound having a partition coefficient that is greater than or equal to a threshold value. As known to those of skill in the chemical arts, the partition coefficient is a measure of the hydrophilicity or hydrophobicity of a chemical compound, such as hydroxamic acid (with a positive partition coefficient indicating a hydrophobic compound). In particular, the partition coefficient is a ratio of concentrations of the chemical compound in a mixture of two immiscible solvents at equilibrium. For the purposes of this disclosure (and as used herein), the partition coefficient is the ratio of the concentration of the hydroxamic acid compound in octanol to the concentration of the hydroxamic acid in water as follows:

$$log P = {log}_{10} ( \frac{{[ HA ]}_{octanol}}{{[ HA ]}_{water}} )$$

where logP represents the partition coefficient and [HA]_{octanol} and [HA]_{water} represent the concentrations of the hydroxamic acid compound HA in octanol and water. It will be appreciated, that the partition coefficient of a chemical compound, such as a hydroxamic acid compound, may be measured or it may be calculated based on the molecular structure of the compound. In certain preferred embodiments, the polishing composition includes a hydroxamic acid compound that has a partition coefficient of at least 0.8 (e.g., at least 0.9, at least 1.0, at least 1.1, or at least 1.2).

In certain advantageous embodiments, R comprises or consists of an aryl group or a substituted aryl group and an alkyl linking group coupling the aryl group or substituted aryl group to a hydroxamic acid group. In preferred embodiments, the alkyl linking group may be a straight chain alkyl group containing from three to eight carbon atoms (e.g., from three to six carbon atoms). The most preferred alkyl linking groups include propyl, butyl, pentyl, and hexyl. In further preferred embodiments, the aryl group is a non-substituted phenyl group or a substituted phenyl group (e.g., an alkyl or alkoxy substituted phenyl group such as methyl or methoxy substituted). Example hydroxamic acid compounds having a phenyl group or a substituted phenyl group include 4-Phenylbutyrl hydroxamic acid (4PhBuHA), 4-(p-anisyl) butyrohydroxamic acid (4pAnisBuHA), 4-(p-tolyl) butyrohydroxamic acid (4pTolBuHA), Cinnamohydroxamic acid (CinHA).

In other advantageous embodiments, R may include a noncyclic alkyl group having from three to ten carbon atoms. As noted above, the term “alkyl” allows for branching and straight-chain groups, and generally refers to a saturated group (e.g., —CnH₂ₙ₊) but does allow for a small degree of unsaturation, e.g., one carbon-carbon double bond or two carbon-carbon double bonds. In preferred embodiments, R is a straight-chain, saturated alkyl group including from four to ten carbon atoms (in most preferred embodiments R includes from six to ten carbon atoms, such as from six to nine carbon atoms or from six to eight carbon atoms). Preferred hydroxamic acid compounds having a non-cyclic alkyl group include butano hydroxamic acid (ButHA), pentano hydroxamic acid (PenHA), hexanohydroxamic acid (HexHA), heptanohydroxamic acid (HepHA), octanohydroxamic acid (OctHA), nonanohydroxamic acid (NonHA), and decanohydroxamic acid (DecHA).

In example polishing compositions that make use of a water based or aqueous liquid carrier, such as deionized water, the hydroxamic acid compound may further advantageously have a suitably high solubility in water. It will be appreciated that higher solubilities enable higher concentrations of the hydroxamic acid compound to be utilized and may therefore enable slurry concentrates to be formulated. However, the disclosed compositions are not necessarily limited in this regard as there are known methods for solubilizing substantially insoluble compounds. Notwithstanding the foregoing, the disclosed polishing compositions may advantageously include a hydroxamic acid compound having an aqueous solubility of at least about 0.1% (e.g., at least about 0.2%, at least about 0.3%, at least about 0.5%, or even at least about 1%).

A pyrone compound may include a 2-pyrone compound, a 4-pyrone compound, and/or derivatives thereof. The pyrone compound preferably includes a 4-pyrone compound as described by the following formula:

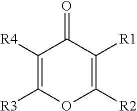

in which R1, R2, R3, and R4 may be hydrogen, hydroxyl, hydroxyalkyl (e.g., hydroxymethyl, hydroxyethyl, hydroxypropyl, and/or hydroxybutyl), and alkyl (e.g., methyl, ethyl, propyl, and/or butyl). Preferred pyrone compounds include maltol, ethyl maltol, and kojic acid with maltol being the most preferred pyrone compound.

The disclosed polishing compositions may include substantially any suitable amount of the hydroxamic acid or pyrone compound. For example, the polishing composition may include 1 ppm by weight (0.0001 wt. %) or more of the hydroxamic acid or pyrone compound at point of use (e.g., 5 ppm or more, 10 ppm or more, 20 ppm or more, 50 ppm or more, 100 ppm or more, or 200 ppm or more). Alternatively, or in addition, the polishing composition may include 1 wt. % (10,000 ppm) or less of the hydroxamic acid or pyrone compound at point of use (e.g., 5000 ppm or less, 2000 ppm or less, 1500 ppm or less, 1000 ppm or less, 750 ppm or less, 500 ppm or less, or 400 ppm or less). Accordingly, the polishing composition may include from about 1 ppm by weight to about 10,000 ppm by weight of the hydroxamic acid or pyrone compound at point of use (e.g., from about 5 ppm to about 5000 ppm, from about 20 ppm to about 2000 ppm, or from about 50 ppm to about 1000 ppm).

It has been found that the preferred amount of hydroxamic acid or pyrone compound may depend on the size of the substrate to be polished and/or on the amount of ceria present in the composition. For example, for applications in which 200 mm wafers are polished and the composition includes about 0.1 wt. % to about 2 wt. % of the disclosed ceria particles, the preferred amount of hydroxamic acid or pyrone compound may be from about 50 ppm to about 500 ppm by weight. For applications in which 300 mm wafers are polished and the composition includes about 0.5 wt. % to about 10 wt. % of the disclosed ceria particles, the preferred amount of hydroxamic acid or pyrone compound may be from about 200 ppm to about 2000 ppm by weight.

The polishing composition may optionally include other chemical materials, additives, or minor ingredients such as a surfactant, a catalyst, an inhibitor, a pH-adjuster and/or buffer, and a biocide, among others. The disclosed embodiments are not limited to including or not including any of such minor ingredients.

The polishing composition may have substantially any suitable pH at point of use. For example, the polishing composition may have a pH of about 2 or more (e.g., about 3 or more, about 3.5 or more, or about 4 or more). Moreover, the polishing composition may have a pH of about 9 or less (e.g., about 8 or less, about 7 or less, about 6.5 or less, or about 6 or less). Accordingly, the polishing composition may have a pH in a range bounded by any two of the aforementioned endpoints, for example, in a range from about 2 to about 9 (e.g., from about 3 to about 8, from about 3.5 to about 6.5, or from about 4 to about 6). It will be appreciated that in example embodiments the polishing composition may be provided as a two-package system, for example, a first package including the ceria particles and a second package including the hydroxamic acid or pyrone compound. In such embodiments, the pH of each package may be in any of the above-described ranges.

The pH of the polishing composition (or of the first package or the second package in a two-package system) may be achieved and/or maintained by any suitable means. The polishing composition may include substantially any suitable pH adjusting agents or buffering systems. For example, suitable acidic pH adjusting agents may include nitric acid, sulfuric acid, phosphoric acid, phthalic acid, citric acid, adipic acid, oxalic acid, malonic acid, maleic acid, ammonium hydroxide, acetic acid, and the like, suitable basic pH adjusting agents may include potassium hydroxide, ammonium hydroxide, alkyl ammonium hydroxides, such as tetrabutylammonium hydroxide, and the like, while suitable buffering agents may include phosphates, sulfates, acetates, malonates, oxalates, borates, ammonium salts, tris family buffers, and the like.

While example embodiments of the disclosed polishing composition may be supplied as a one-package system, the polishing composition may be advantageously provided as a two-package system. For example, the disclosed polishing composition may be supplied as a first package including the ceria particles (such as the first ceria particles and the second ceria particles) and a second package including the hydroxamic acid or pyrone compound. The first and second packages may be combined, e.g., by the end-user, on the polishing pad (e.g., via in-line mixing) or shortly before use (e.g., 1 week or less prior to use, 1 day or less prior to use, 1 hour or less prior to use, 10 minutes or less prior to use, or 1 minute or less prior to use).

The disclosed polishing compositions may also be provided as a concentrate which is intended to be diluted with an appropriate amount of water prior to use. In such concentrated embodiments, the polishing composition concentrate may include the ceria particles, the hydroxamic acid or pyrone compound, water, and other optional components, such as a biocide, in amounts such that, upon dilution of the concentrate with an appropriate amount of water, each component of the polishing composition will be present in the polishing composition in an amount within the appropriate ranges recited above for each component. For example, the ceria particles, the hydroxamic acid or pyrone compound, and other optional components may each be present in the polishing composition in an amount that is about 2 times (e.g., about 3 times, about 4 times, about 5 times, or even up to about 8 times) greater than the point of use concentrations recited above for each component so that, when the concentrate is diluted with an equal volume of (e.g., 2 equal volumes of water, 3 equal volumes of water, 4 equal volumes of water, or 7 equal volumes of water) each component will be present in the polishing composition in an amount within the ranges set forth above for each component. In example compositions that are supplied as a two-package system, it will be appreciated that either one or both of the packages may also optionally be supplied as a concentrate with appropriate amounts of each component such that upon dilution and combining the two packages each component will be present in the polishing composition in an amount within the ranges set forth above.

The disclosed polishing compositions may be used to polish substantially any substrate, for example, including a dielectric layer such as a silicon oxide layer. Certain advantageous embodiments may be particularly useful in the polishing of a substrate including a patterned silicon oxide layer such as those employed in 3D NAND devices. The polishing method of the invention is particularly suited for use in conjunction with a chemical mechanical polishing (CMP) apparatus. Typically, the apparatus includes a platen, which, when in use, is in motion and has a velocity that results from orbital, linear, or circular motion, a polishing pad in contact with the platen and moving with the platen when in motion, and a carrier that holds a substrate to be polished by contacting and moving relative to the surface of the polishing pad. The polishing of the substrate takes place by the substrate being placed in contact with the polishing pad and the polishing composition of the invention and then the polishing pad moving relative to the substrate, so as to abrade at least a portion of the substrate (such as a silicon oxide dielectric material as described herein) to polish the substrate.

A substrate may be planarized or polished with the chemical mechanical polishing composition with any suitable polishing pad (e.g., polishing surface). Suitable polishing pads include, for example, woven and non-woven polishing pads. Moreover, suitable polishing pads may comprise any suitable polymer of varying density, hardness, thickness, compressibility, ability to rebound upon compression, and compression modulus. Suitable polymers include, for example, polyvinylchloride, polyvinylfluoride, nylon, fluorocarbon, polycarbonate, polyester, polyacrylate, polyether, polyethylene, polyamide, polyurethane, polystyrene, polypropylene, co-formed products thereof, and mixtures thereof.

The following examples further illustrate the invention but, of course, should not be construed as in any way limiting its scope.

### Example 1

Fourteen ceria dispersions were prepared. The particle size and surface area of the ceria particles in each of the ceria dispersions was measured using CPS, DMA, and BET SSA. The particle sizes and surface areas are listed in Table 1. In this particular example, Ceria 1H is a 90:10 blend (by weight) of Ceria 1D and Ceria 1E. Ceria 1I is an 80:20 blend (by weight) of Ceria 1D and Ceria 1E. Ceria 1J is a 70:30 blend (by weight) of Ceria 1D and Ceria 1E. And Ceria 1K is a 60:40 blend (by weight) of Ceria 1D and Ceria 1E. Moreover, Ceria 1L is a 90:10 blend (by weight) of Ceria 1A and Ceria 1E. Ceria 1M is an 80:20 blend (by weight) of Ceria 1A and Ceria 1E. And Ceria 1N is a 60:40 blend (by weight) of Ceria 1A and Ceria 1E.

TABLE 1

| | Particle | Particle | Particle | Surface |
|---|---|---|---|---|
| | Size CPS | Size CPS | Size DMA | Area BET |
| Ceria | (D_{w}) (nm) | (Dₙ) (nm) | (Dₙ) (nm) | (m²/g) |
| 1A | 105 | 55 | 50 | 22 |
| 1B | 136 | 105 | 120 | 13 |
| 1C | 96 | 51 | 39 | 35 |
| 1D | 128 | 66 | 49 | 14 |
| 1E | 47 | 25 | 24 | 168 |
| 1F | 55 | 47 | 54 | 34 |
| 1G | 24 | 22 | 22 | 87 |
| 1H | 120 | 47 | 29 | 43 |
| 1I | 113 | 43 | 20 | 62 |
| 1J | 109 | 40 | 23 | 89 |
| 1K | 98 | 30 | 32 | 100 |
| 1L | 92 | 41 | 24 | 43 |
| 1M | 93 | 42 | 21 | 65 |
| 1N | 88 | 33 | 21 | 124 |

As set forth in table 1, the ceria dispersions included ceria particles having weight average particle sizes ranging from 24 nm to 136 nm and number average particle sizes ranging from 22 nm to 105 nm. Moreover, the ceria particles had surface areas ranging from 13 to 168 m²/g. Note that for Cerias 1A-1G the measured surface area is somewhat inversely correlated with the measured particle size such that particles having a large particle size also tend to have a small surface area. In contrast, Cerias 1I, 1J, and 1K had both a large particle size (98 nm and above) and a moderately high surface area (62 m²/g and above). Ceria 1M also had both a large particle size (93 nm) and a moderately high surface area (65 m²/g).

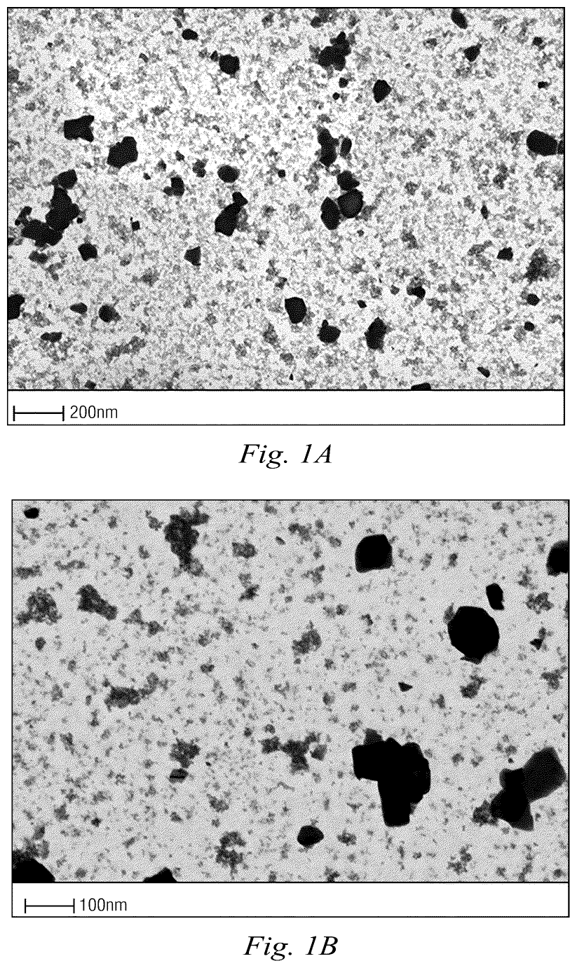

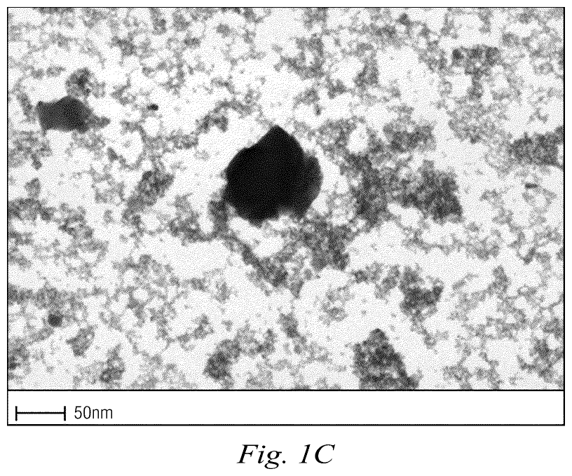

SEM images of Ceria 1I are shown on FIG. 1.

### Example 2

Six polishing compositions were prepared. Each of the polishing compositions included 0.5 weight percent ceria. Polishing compositions 2A, 2C, and 2E included Ceria 1A described above in Example 1. Polishing compositions 2B, 2D, and 2F included Ceria 1M, a blend of 80% by weight of Ceria 1A and 20% by weight of Ceria 1E (i.e., 0.4 weight percent Ceria 1A and 0.1 weight percent Ceria 1E). Polishing compositions 2A and 2B included no polishing rate accelerators. Polishing compositions 2C and 2D further included 500 ppm by weight picolinic acid. Polishing compositions 2E and 2F further included 633 parts per million by weight benzohydroxamic acid (BHA). Each of the polishing compositions had a pH of 5.5.

The CMP performance of polishing compositions 2A-2F was evaluated using a Mirra® CMP polishing tool (Applied Materials) with an E6088 polishing pad (Entegris) and in-situ conditioning using a Saesol DS8051 disk conditioner at 6 lbs. Polishing removal rates were obtained by polishing 200 mm blanket and patterned TEOS wafers at a downforce of 3.0 psi, a platen speed of 100 rpm, a head speed of 85 rpm, and a slurry flow rate was 150 mL/min. Blanket wafer and patterned wafer polishing rates are shown in Table 2. The patterned wafer rates are reported for a 900×900 μm feature.

TABLE 2

| Polishing | | Polishing Rate | Blanket Rate | Pattern Rate |
|---|---|---|---|---|
| Composition | Ceria | Accelerator | (Å/min) | (Å/min) |
| 2A | 1A | — | 6805 | 5811 |
| 2B | 1M | — | 9705 | 5132 |
| 2C | 1A | Picolinic Acid | 7066 | 7547 |
| 2D | 1M | Picolinic Acid | 7266 | 3756 |
| 2E | 1A | BHA | 7833 | 7771 |
| 2F | 1M | BHA | 9711 | 10,179 |

As is apparent from the results set forth in table 2, Ceria 1M provides significantly improved blanket TEOS removal rates but reduced pattern removal rates (comparing composition 2B to composition 2A). The addition of picolinic acid improves the removal rates for composition 2C but resulted in lower removal rates for composition 2D (including the blended ceria). The addition of hydroxamic acid (BHA in this example) improves the blanket removal rates in composition 2E and significantly improves the pattern removal rates when used with the blended ceria in composition 2F. It is apparent that the combination of the hydroxamic acid and ceria 1M provides superior removal rates.

### Example 3

Eight polishing compositions were prepared. Each of the polishing compositions included 0.5 weight percent ceria 1I (including a blend of 0.4 weight percent Ceria 1D and 0.1 weight percent Ceria 1E). Polishing compositions 3A included no polishing rate accelerators. Polishing compositions 3B and 3C further included 280 ppm by weight and 560 ppm by weight BHA. Polishing compositions 3D, 3E, and 3F further included 25 ppm, 100 ppm, and 250 ppm by weight maltol. Polishing compositions 3G and 3H further included 500 ppm and 1000 ppm by weight picolinic acid. Each of the polishing compositions had a pH of 5.5.

The CMP performance of polishing compositions 3A-3H was evaluated using a Mirra® CMP polishing tool (Applied Materials) with an E6088 polishing pad (Entegris) and in-situ conditioning using a Saesol DS8051 disk conditioner at 6 lbs. Polishing removal rates were obtained by polishing 200 mm blanket and patterned TEOS wafers at a downforce of 3.0 psi, a platen speed of 100 rpm, a head speed of 85 rpm, and a slurry flow rate was 150 mL/min. Blanket wafer and patterned wafer polishing rates are shown in Table 3. The patterned wafer rates are reported for a 900×900 μm line feature.

TABLE 3

| Polishing | Polishing Rate | Blanket Rate | Pattern Rate |
|---|---|---|---|
| Composition | Accelerator | (Å/min) | (Å/min) |
| 3A | — | 9206 | 8198 |
| 3B | 280 ppm BHA | 9126 | 7843 |
| 3C | 560 ppm BHA | 8802 | 8498 |
| 3D | 25 ppm Maltol | 9625 | 7908 |
| 3E | 100 ppm Maltol | 9952 | 8272 |
| 3F | 250 ppm Maltol | 8762 | 10,352 |
| 3G | 500 ppm Picolinic Acid | 8366 | 7256 |
| 3H | 1000 ppm Picolinic Acid | 6714 | 5069 |

As is apparent from the results set forth in table 3, composition 3F including Ceria 1I and 250 ppm of maltol provided superior pattern removal rates. As in Example 2, the use of picolinic acid resulted in a reduction in blanket and pattern removal rates.

### Example 4

Six polishing compositions were prepared. Each of the polishing compositions included a total of 0.5 weight percent ceria. Polishing compositions 4A and 4B included a blend of 0.4 weight percent Ceria 1C and 0.1 weight percent Ceria 1E. Polishing compositions 4C and 4D included Ceria 1M, a blend of 80% by weight of Ceria 1A and 20% by weight of Ceria 1E. Polishing compositions 4E and 4F included Ceria 1I (a blend of 80% by weight of Ceria 1D and 20% by weight of Ceria 1E). Polishing compositions 4A, 4C, and 4E included no polishing rate accelerators. Polishing compositions 4B, 4D, and 4F further included 244, 633, and 633 parts per million by weight (BHA). The amount of BHA was scaled to the surface area of the larger particle in the blend. The pH of each composition was 5.5.

The CMP performance of polishing compositions 2A-2F was evaluated using a Mirra® CMP polishing tool (Applied Materials) with an E6088 polishing pad (Entegris) and in-situ conditioning using a Saesol DS8051 disk conditioner at 6 lbs. Polishing removal rates were obtained by polishing 200 mm blanket and patterned TEOS wafers at a downforce of 3.0 psi, a platen speed of 100 rpm, a head speed of 85 rpm, and a slurry flow rate was 150 mL/min. Blanket wafer and patterned wafer polishing rates are shown in Table 4. The patterned wafer rates are reported for a 900×900 μm line feature.

TABLE 4

| Polishing | | Polishing Rate | Blanket Rate | Pattern Rate |
|---|---|---|---|---|
| Composition | Ceria | Accelerator | (Å/min) | (Å/min) |
| 4A | 1C + 1E | — | 9384 | 1415 |
| 4B | 1C + 1E | BHA | 8943 | 9275 |
| 4C | 1M | — | 9705 | 5132 |
| 4D | 1M | BHA | 9711 | 10,179 |
| 4E | 1I | — | 9206 | 8198 |
| 4F | 1I | BHA | 9808 | 11,363 |

As is apparent from the results set forth in Table 4, the highest removal rates were achieved for compositions including the blended ceria and the hydroxamic acid (compositions 4B, 4D, and 4F). Moreover, in this example the removal rates increased with increasing particle size and decreasing surface area of the large particle in the blend.

### Example 5

Five polishing compositions were prepared. Each of the polishing compositions included a total of 0.5 weight percent of a blended ceria (0.4 weight percent of one of Ceria 1B or Ceria 1D and 0.1 weight percent of one of Ceria 1E, Ceria 1F, or Ceria 1G). Polishing composition 5A included Ceria 1I (an 80:20 blend of Ceria 1D and Ceria 1E). Polishing composition 5B included a blend of Ceria 1D and Ceria 1F. Polishing composition 5C included a blend of Ceria 1D and Ceria 1G. Polishing composition 5D included a blend of Ceria 1B and Ceria 1F. Polishing composition 5E included a blend of Ceria 1B and Ceria 1G (see Example 1). None of the polishing compositions included a polishing rate accelerator. The pH of each composition was 5.5.

The CMP performance of polishing compositions 2A-2F was evaluated using a Mirra® CMP polishing tool (Applied Materials) with an E6088 polishing pad (Entegris) and in-situ conditioning using a Saesol DS8051 disk conditioner at 6 lbs. Polishing removal rates were obtained by polishing 200 mm blanket and patterned TEOS wafers at a downforce of 3.0 psi, a platen speed of 100 rpm, a head speed of 85 rpm, and a slurry flow rate was 150 mL/min. Blanket wafer and patterned wafer polishing rates are shown in Table 5. The patterned wafer rates are reported for a 900×900 μm feature.

TABLE 5

| Polishing | Ceria Blend | Blanket Rate | Pattern Rate |
|---|---|---|---|
| Composition | (80:20) | (Å/min) | (Å/min) |
| 5A | 1D and 1E | 8114 | 5964 |
| 5B | 1D and 1F | 6146 | 4085 |
| 5C | 1D and 1G | 6738 | 1068 |
| 5D | 1B and 1F | 6348 | 4486 |
| 5E | 1B and 1G | 5382 | 521 |

As is evident from the data set forth in table 5, polishing compositions 5A, 5B, and 5D achieved superior pattern removal rates. While no hydroxamic acid was present in these compositions, it is expected that compositions 5A, 5B, and 5D would achieve superior removal rates with the addition of hydroxamic acid (as demonstrated above in Examples 2 and 4). Moreover, it is evident in this example that the removal rates increased when the small particle in the blend had an intermediate particle size. It was further observed that the best performing small particle in the blend included an intermediate particle size and a high surface area (5A).

### Example 6

Five polishing compositions were prepared. Each of the polishing compositions included a total of 2.67 weight percent ceria. Polishing composition 6A included Ceria 1D. Polishing composition 6B included Ceria 1H. Polishing composition 6C included Ceria 1I. Polishing composition 6D included Ceria 1J. Polishing composition 6E included Ceria 1K. The pH of each composition was 6.

The CMP performance of polishing compositions 6A-6E was evaluated using a Refexion® CMP polishing tool (Applied Materials) with a thermosetting polyurethane (TSU) polishing pad having a Shore D hardness of about 68 and in-situ conditioning using a Saesol DS8051 disk conditioner at 6 lbs. Polishing removal rates were obtained by polishing 300 mm blanket TEOS wafers at a downforce of 3.5 psi, a platen speed of 126 rpm, a head speed of 125 rpm, and a slurry flow rate was 250 mL/min. Blanket wafer polishing rates are shown in Table 6. The patterned wafer rates are reported for a 900×900 μm line feature.

TABLE 6

| Polishing | Ceria Blend | Blanket Rate |
|---|---|---|
| Composition | (1D:1E) | (Å/min) |
| 6A | 100:0 | 19,404 |
| 6B | 90:10 | 20,529 |
| 6C | 80:20 | 24,955 |
| 6D | 70:30 | 29,322 |
| 6F | 60:40 | 28,657 |

As is readily apparent from the data set forth in table 6, polishing compositions 6C, 6D, and 6E including the 80:20, 70:30, and 60:40 blends achieved superior blanket removal rates.

### Example 7

Thirteen polishing compositions were prepared. Each of the polishing compositions included 0.5 weight percent of Ceria 1I. Each polishing composition further included a hydroxamic acid polishing rate accelerator. Polishing composition 7A did not include a hydroxamic acid polishing rate accelerator. Polishing composition 7B included 0.54 mM of the hydroxamic acid polishing rate accelerator. Polishing compositions 7C, 7D, 7E, 7F, 7G, 7H, and 7I included 0.73 mM of the hydroxamic acid polishing rate accelerator. And polishing compositions 7J, 7K, 7L, and 7M included 1.46 mM of the hydroxamic acid polishing rate accelerator. The amount and type of each hydroxamic acid are listed in Table 7A. The pH of each composition was 5.5.

The CMP performance of each of the polishing compositions 7A-7M was evaluated using a Mirra® CMP polishing tool (Applied Materials) with an E6088 polishing pad (Entegris) and in-situ conditioning using a Saesol DS8051 disk conditioner at 6 lbs. Polishing removal rates were obtained by polishing 200 mm blanket and patterned TEOS wafers at a downforce of 3.0 psi, a platen speed of 100 rpm, a head speed of 85 rpm, and a slurry flow rate was 150 mL/min. Blanket wafer and patterned wafer polishing rates are shown in Table 7B. The patterned wafer rates are reported for a 900×900 μm line feature.

TABLE 7A

| Polishing | | Concentration |
|---|---|---|
| Composition | Hydroxamic Acid | (mM) |
| 7A | — | — |
| 7B | Benzyloxyacetohydroxamic acid | 0.54 |
| 7C | Benzohydroxamic acid | 0.73 |
| 7D | 2-Methylbenzohydroxamic acid | 0.73 |
| 7E | 4-Fluoro hydroxamic acid | 0.73 |
| 7F | 4-Phenylbutyrl hydroxamic acid | 0.73 |
| 7G | 4-(p-anisyl)butyrohydroxamic acid | 0.73 |
| 7H | 4-(p-tolyl)butyrohydroxamic acid | 0.73 |
| 7I | Cinnamohydroxamic acid | 0.73 |
| 7J | Hexanohydroxamic acid | 0.73 |
| 7K | Octanohydroxamic acid | 0.73 |
| 7L | Benzohydroxamic acid | 1.46 |
| 7M | 2-Methylbenzohydroxamic acid | 1.46 |
| 7N | 4-Fluoro hydroxamic acid | 1.46 |
| 7O | 4-Phenylbutyrl hydroxamic acid | 1.46 |
| 7P | Hexanohydroxamic acid | 1.46 |
| 7Q | Octanohydroxamic acid | 1.46 |

TABLE 7B

| Polishing | Blanket Rate | Pattern Rate |
|---|---|---|
| Composition | (Å/min) | (Å/min) |
| 7A | 9756 | 5862 |
| 7B | 10,321 | 10,770 |
| 7C | 10,507 | 9965 |
| 7D | 10,408 | 9,976 |
| 7E | 10,521 | 10,820 |
| 7F | 10,267 | 11,899 |
| 7G | 10,346 | 11,975 |
| 7H | 9874 | 12,809 |
| 7I | 11,087 | 11,883 |
| 7J | 10,275 | 10,948 |
| 7K | 10,003 | 11,551 |
| 7L | 10,564 | 11,017 |
| 7M | 10,395 | 11,344 |
| 7N | 9,776 | 10,436 |
| 7O | 8735 | 12,429 |
| 7P | 10,014 | 11,496 |
| 7Q | 5,337 | 11,637 |

As is evident from the data set forth in table 7B, each of the polishing compositions including hydroxamic acid significantly improves the pattern removal rate when used in combination with the blended ceria. Compositions including a hydroxamic acid with a phenyl group or a substituted phenyl group were observed to provide the most significant improvement in pattern removal rate, particularly in compositions in which an alkyl linking group is interposed between the phenyl group and the hydroxamic acid group as in polishing compositions 7E, 7F, 7G, and 7H. Moreover, composition including a straight chain alkyl group were also found to provide a highly significant improvement in pattern removal rate as in polishing compositions 7J, 7K, 7P, and 7Q.

### Example 8

The aqueous solubility was measured and the partition coefficient was computed for nineteen hydroxamic acid compounds. To measure the aqueous solubility, a supersaturated solution of each hydroxamic acid compound was prepared in deionized water. The pH was adjusted to 5.5 using nitric acid and the supersaturated solution was stirred overnight. Excess solids were removed via filtration and the hydroxamic acid compound in solution was quantified using 1H NMR with a t-BuOH standard. No significant impurities were observed for any of the hydroxamic acid compounds tested. It was not possible to achieve super saturation for the 2-furohydroxamic acid compound. The actual solubility was greater than the 17.8% that is reported herein. The partition coefficients were computed using the procedure described in Wildman, Scott A. and Crippen, Gordon M., Prediction of Physicochemical Parameters by Atomic Contributions, J. Chem. Inf. Comput. Sci. 1999, 39, 5, 868-873. Briefly, an atom type classification system was used for an atom-based calculation of the partition coefficient (log P) and the molar refractivity (MR). The hydroxamic acid compounds and the corresponding aqueous solubility and partition coefficient are listed in table 8.

TABLE 8

| | Aqueous | Partition |
|---|---|---|
| Hydroxamic Acid | Solubility | Coefficient |
| Picolinichydroxamic acid | 3.0% | 0.2 |
| 2-furohydroxamic acid | >17.8% | 0.4 |
| Benzyloxyacetohydroxamic acid | 1.8% | 0.7 |
| N-hydroxy-2-phenyl-acetamide | 1.5% | 0.7 |
| 4-Cyano-N-hydroxybenzamide | 0.5% | 0.7 |
| Benzohydroxamic acid | 3.6% | 0.8 |
| 2-Methoxybenzohydroxamic acid | 1.1% | 0.8 |
| 4-Methoxybenzohydroxamic acid | 0.4% | 0.8 |
| 3-Fluoro hydroxamic acid | 1.3% | 0.9 |
| 4-Fluoro hydroxamic acid | 1.0% | 0.9 |
| 2-Fluoro hydroxamic acid | 1.0% | 0.9 |
| Hexanohydroxamic acid | 4.8% | 1.1 |
| 2-Methylbenzohydroxamic acid | 3.3% | 1.1 |
| 4-Methylbenzohydroxamic acid | 0.5% | 1.1 |
| Cinnamohydroxamic acid | 0.6% | 1.2 |
| 4-Phenylbutyrl hydroxamic acid | 1.6% | 1.5 |
| 4-(p-anisyl)butyrohydroxamic acid | 0.5% | 1.5 |
| 4-(p-tolyl)butyrohydroxamic acid | 0.2% | 1.8 |
| Octanohydroxamic acid | 0.2% | 1.9 |

It will be understood that the recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A chemical mechanical polishing composition comprising:
a liquid carrier;
ceria particles dispersed in the liquid carrier, the ceria particles having a weight average particle size of greater than 90 nm as measured using a CPS Disc Centrifuge Particle size analyzer and a BET surface area of greater than 50 m²/g; and
a hydroxamic acid compound or a pyrone compound.

2. The polishing composition of claim 1, comprising a first package and a second package, wherein the first package comprises the ceria particles and the second package comprises the hydroxamic acid compound or the pyrone compound.

3. The polishing composition of claim 1, wherein the ceria particles have a weight average particle size of greater than 100 nm as measured using the CPS Disc Centrifuge Particle size analyzer and a BET surface area of greater than 60 m²/g.

4. The polishing composition of claim 1, wherein the ceria particles have a BET surface area of less than 100 m²/g.

5. The polishing composition of claim 1, wherein the ceria particles further have a number average particle size of less than 50 nm as measured using the CPS Disc Centrifuge Particle size analyzer.

6. The composition of claim 1, wherein the hydroxamic acid compound has a partition coefficient of at least 0.8.

7. The polishing composition of claim 1, wherein the hydroxamic acid comprises an aryl group or a substituted aryl group.

8. The polishing composition of claim 1, wherein the hydroxamic acid comprises a phenyl group or a substituted phenyl group.

9. The polishing composition of claim 8, wherein the hydroxamic acid comprises 4-Phenylbutyrl hydroxamic acid, 4-(p-anisyl) butyrohydroxamic acid, 4-(p-tolyl) butyro hydroxamic acid, Cinnamohydroxamic acid, or a mixture thereof.

10. The polishing composition of claim 1, wherein the hydroxamic acid comprises a non-cyclic alkyl group and a hydroxamic acid group.

11. The polishing composition of claim 10 wherein the hydroxamic acid comprises butano hydroxamic acid, pentano hydroxamic acid, hexano hydroxamic acid, heptano hydroxamic acid, octano hydroxamic acid, nonano hydroxamic acid, decano hydroxamic acid, or a mixture thereof.

12. The polishing composition of claim 1, wherein the pyrone compound comprises a 4-pyrone compound.

13. The polishing composition of claim 12, wherein the 4-pyrone compound comprises maltol, ethyl maltol, kojic acid, or a mixture thereof.

14. The polishing composition of claim 1, comprising from about 0.1 to about 10 weight percent of the ceria particles at point of use and about 50 to about 2000 ppm by weight of the hydroxamic acid or pyrone compound.

15. The polishing composition of claim 1, having a pH in a range from about 4 to about 9 at point of use.

16. The polishing composition of claim 1, wherein the ceria particles comprise first ceria particles having a weight average particle size of greater than 100 nm as measured using a CPS Disc Centrifuge Particle size analyzer and second ceria particles having a weight average particle size between 30 nm and 60 nm as measured using a CPS Disc Centrifuge Particle size analyzer.

17. The polishing composition of claim 1, wherein the first ceria particles have a surface area of less than about 40 m²/g.

18. The polishing composition of claim 16, wherein the second ceria particles have a surface area of greater than about 100 m²/g.

19. The polishing composition of claim 16, wherein the first ceria particles comprise calcined ceria particles and the second ceria particles comprise wet ceria particles.

20. The polishing composition of claim 16, wherein a weight ratio of the first ceria particles to the second ceria particles is in a range from about 3:2 to about 9:1.
